(19) United States
(12) Patent Application Publication
(10) Pub. No.: US 2002/0165784 A1
(43) Pub. Date: Nov. 7, 2002

(54) Launch service or purchase request directly from a network-enabled appliance

(76) Inventors: John Taggart, Meridian, ID (US); Daniel Ruegemer, Mountain View, CA (US); Jeroen VanAlphen, Amsterdam (NL)

Correspondence Address: HEWLETT-PACKARD COMPANY, Intellectual Property Administration, P.O. Box 272400, Fort Collins, CO, 80527-2400, US

(21) Appl. No.: 09/795,485

(22) Filed: Mar. 1, 2001

(51) Int. Cl. G06F 17/60

(52) U.S. Cl. 705/26

(57) ABSTRACT

A method and an apparatus allow launch of a service request or a product purchase request directly from a browser session. A device, coupled to a web-enabled appliance, receives event information from the appliance and provides the information to a portal to initiate the browser session. A server at the portal analyzes the event information and provides suggestions for responding to the event. The suggestions may be listed in a page that is posted to the device. The page may provide links to other pages, and may allow a client to purchase services, products, consumables, software, manuals and documents, and warranties from the portal or from remote locations coupled to the portal.

### TECHNICAL FIELD

The technical field relates to an apparatus and method for gathering information for events relating to a networked appliance and transmitting alert messages concerning particular events.

### BACKGROUND

Computers are often connected to or networked with various appliances such as printers. These appliances can experience errors such as when a printer has a paper jam or is out of toner. A computer user may only detect the error through a physical inspection of the appliance. Upon detecting the error, the computer user typically must manually call or send an e-mail to the manufacturer or other company that services the appliance. The use of a manual way to send the notification results in a cumbersome and inefficient situation.

Also, the user's physical inspection of the appliance may not necessarily detect all or most events relevant to the error. For example, a paper jam in a printer can be caused by a failure of mechanical components; however, the user may only detect the paper jam and not detect anything concerning the components causing the error. Therefore, when reporting the error, the user may not necessarily have the best or most relevant information for the servicing company.

Once the user has experienced an error, the next logical step is to correct the error. With current systems, the error reporting process may require that the user call a customer representative or access a Web site, and then engage in a difficult and lengthy process to describe the appliance error, identify a solution, and obtain any needed products or services. This cumbersome way for addressing appliance errors leaves many users frustrated and may significantly slow resolution of the problem. Furthermore, as noted above, the user may not have the most relevant information, or may actually have incorrect information regarding the problem, which can result in a delayed or inefficient servicing of the appliance.

### SUMMARY

An apparatus and method gather data and provide messages concerning a networked appliance. An occurrence of an event relating to the networked appliance is detected, and an indication of the event is recorded. The method is used to determine whether the event is associated with an alert message, and the alert message is selectively transmitted to a client machine based upon that determination.

The apparatus and method can repeatedly record the indications of the events. Upon detecting an event associated with an alert message, a set of the indications can be selected and transmitted with the alert message. Upon viewing the alert message, the client can, for example, use the message in order to report to a system server the indications of the events and errors for the appliance.

Once errors are reported, the system can formulate one or more solutions, and present those solutions to the client. The solutions may be to provide the client with self help, particularly for non-critical (client-repairable) errors, or to offer a service to correct the error. The service may involve dispatching a repairman to the client's site or downloading software that will correct operation of the appliance, for example.

### DESCRIPTION OF THE DRAWINGS

The detailed description will refer to the following drawings in which like elements are referred to by like numerals, and in which:

FIG. 1 is a diagram of a networked system for gathering data for appliances and providing alert messages concerning the appliances;

FIG. 2 is a flow chart of a method for recording of event information for networked appliances;

FIG. 3 is a flow chart of a method for receiving alert messages for an appliance and providing associated event information to a system server;

FIG. 4 is a diagram of an appliance home page for displaying an alert message concerning an appliance;

FIG. 5 is a more detailed diagram of a system for gathering data from a web-enabled appliance and for launching service requests or purchasing products;

FIG. 6 is a diagram of data sources used with the system of FIG. 5;

FIG. 7 is a diagram of a database used with the system of FIG. 5;

FIG. 8 shows an embodiment of an architecture for a Web site in the system of FIG. 5;

FIG. 9 is a logical diagram of functions available at a portal in the system of FIG. 5;

FIG. 10 illustrates three possible usage models applicable to the portal shown in FIG. 5;

FIG. 11A is a detailed workflow model for an alert process used by the system of FIG. 5;

FIG. 11B is a diagram illustrating a normal navigation process at the portal shown in FIG. 5;

FIG. 11C is a diagram illustrating an appliance-specific navigation process at the portal shown in FIG. 5;

FIG. 12 is a diagram of a generic home page used with the portal;

FIGS. 13-18 are examples of specific pages provided by the portal; and

FIGS. 19-22 are flowcharts illustrating processes completed by the portal.

### DETAILED DESCRIPTION

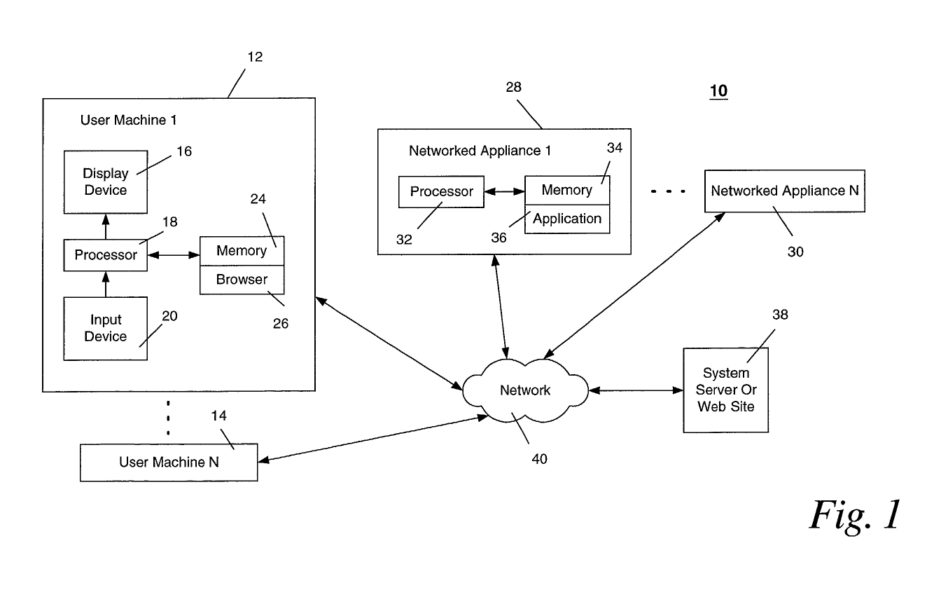

FIG. 1 is a diagram of a networked system 10 for gathering data for appliances and providing alert messages concerning the appliances. System 10 includes one or more client machines 12 and 14 connected to a network 40 such as the Internet, an intranet, or other local area or wide area network. As illustrated in client machine 12, each of the client machines may include, for example, a processor 18, a display device 16, and input device 20, and output device 22, and a memory 24. Processor 18 is connected with memory 24 in order to execute one or more applications stored in the memory such as a web browser 26. A client can enter information commands into client machine 12 via an input device 20, and may view information output on display device 16 or other output device 22.

The client machines 12 and 14 are typically connected through network 40 to one or more networked appliances 28 and 30. As illustrated in networked appliance 28, each networked appliance may include, for example, a processor 32 connected with a memory 34. Memory 34 may include one or more applications 36 for execution by processor 32. Each networked appliance typically includes additional components depending upon the type of appliance. For example, if network appliance 28 is implemented with a printer, it will also include the necessary mechanical and other components to, under control of processor 32, receive information and print the information onto paper or other material.

Other examples of networked appliances include a fax machine, other types of display devices such as projectors, and various other types of output devices. The phrase “networked appliance” includes any processor based device capable of communication over a network.

System 10 also typically includes a system server or Web site 38 connected to network 40. System server 38 may represent, for example, a server associated with a company servicing one or more of the networked appliances 28 and 30. Also, as indicated, the system server can optionally host a Web site. Therefore, alert messages concerning errors in the networked appliance can be sent via a network 40 to system server 38, to a Web site, or to both.

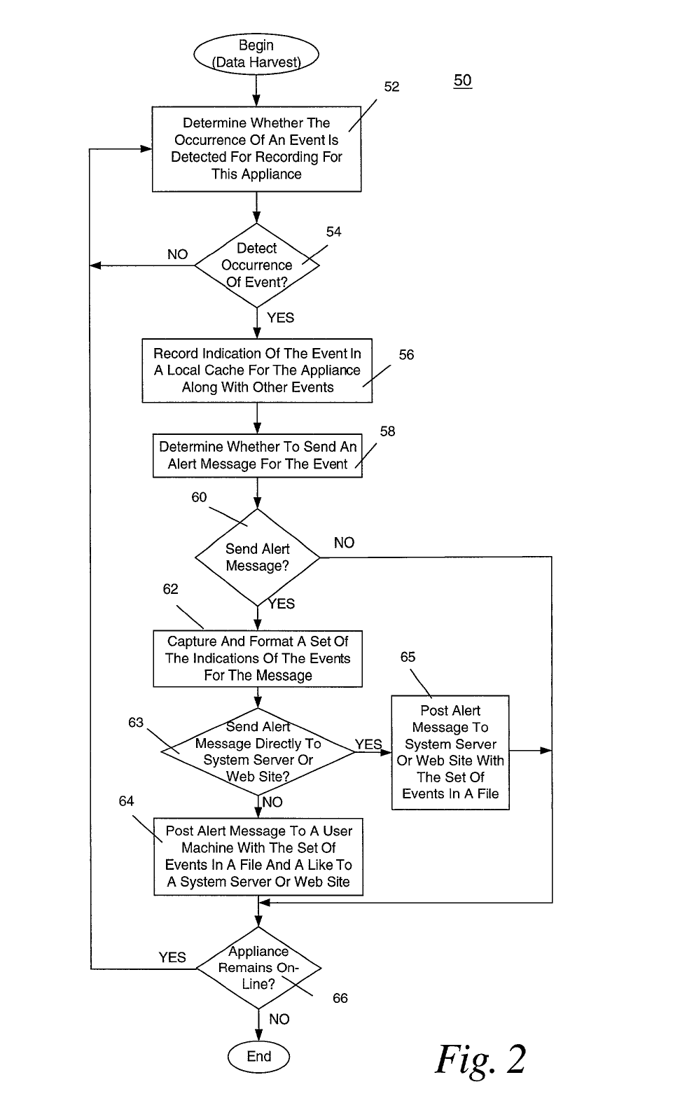

FIG. 2 is a flowchart of a method 50 for harvesting data from networked appliances 28 and 30. Method 50 can be implemented, for example, as software modules stored within memory 34 for execution by processor 32 resident within a networked appliance. In method 50, the appliance determines whether it detects the occurrence of an event for recording for this appliance (block 52). Each particular type of networked appliance may operate in a certain way and produce particular events based upon its own operation. For example, a printer may generate different types of events for recording than a fax machine. Memory 34 within the networked appliance may store in a data structure an indication of the types of events to record for this particular appliance, and those events can be predetermined, or dynamically changed and updated during operation of the appliance (block 54).

If the occurrence of such an event is detected (block 54), the appliance records an indication of the event in a local cache such as memory 34 usually along with any other events that have been recorded for this appliance (block 56). An indication of an event can include any information related to or identifying the event such as, for example, the event itself, information describing the event, information identifying the event, or information qualifying or quantifying the event. These events are typically recorded in real-time or near real-time and in sequential order based upon when they are detected. The events may be stored in a particular data structure such as an Extensible Markup Language (XML) string, a relational database table, or other structure. Since processor 32 controls operation of the appliance, the processor 32 may detect occurrence of a wide variety of events for the appliance, and the application 36 may be configured to monitor those events and record selected events.

The appliance also determines whether to send an alert message to one of the client machines for this event (block 58). Certain types of events for particular networked appliances may be categorized as events for which an alert message should be sent. For example, certain events may involve an error in the networked appliance and thus should typically be reported, whereas other events may simply relate to status information or a general operation of the networked appliance. The events for which an alert message should be sent can be predetermined or dynamically changed and updated, and an indication of those types of events may be stored within memory 34.

If an alert message should be sent (block 60), the networked appliance captures and formats a set of the indications of the events for the message (block 62). In other words, the appliance in effect captures a “snapshot” of the events relating to or associated with the event resulting in the alert message. For example, application 36 may be implemented with a Java applet, which may be used by processor 32 to access the recorded indications of events and retrieve a certain number of the most recent events. For example, in one embodiment the appliance maintains a recordation of the last fifty events for the appliance, and the last five events are captured within the fifty for transmitting with an alert message; other numbers of total events and a set of events may be used. The alert message thus includes in this example a set of events having the closest temporal relation to the event causing the alert. Selection of the set of events can be based upon a wide variety of factors in relation to the event causing the alert, such as, for example, the following: a temporal relation to the event; types of events recorded; relationships between the alert event and recorded events; the type of appliance being monitored; or other criteria.

The application then formats the events for network transmission and can also include other information with the events such as an identification of the networked appliance and its location. The appliance determines whether to send the alert message directly to system server or Web site 38, block 63. The appliance may send the alert message, and associated set of events, to a client machine, to a system server or Web site, or to both. The appliance may also send the information to more than one of each of those entities. In order to make that determination, the appliance can store in memory 34 a table or other data structure specifying the entities for sending the information, and the appliance may also specify a network address for the entities such as, for example, a Uniform Resource Locator (URL).

If the appliance is configured to send an alert message directly to a system server or Web site, the appliance posts an alert message to the one or more system servers or web sites with the set of events in a file (block 65). Otherwise, the appliance may post an alert message to one or more of the user machines 12 and 14 with the set of events in a file, for example, and a link to system server or web site 38 (block 64). If the appliance is configured to send an alert message to both a user computer and a system server or web site, the appliance perform both blocks 64 and 65 either simultaneously or in any order. The events for posting in block 64 can be saved in blocks, for example, a hidden file so that they are associated with the alert message but not displayed to a user; alternatively, the events can be selectively displayed to the user along with the alert message. For block 65, the events can also be saved in a hidden file to use the same data structure for saving the events for both block 64 and 65, or they can be saved in a different type of file or data structure for block 65.

As part of determining which entities should receive an alert message, the appliance can determine which one or more user machines should receive the posted information. It can post the alert message to the last user machine to send data to the appliance, for example, or be programmed to send the alert message to one or more of the user machines based upon particular criteria such as an identification of users at the user machines, users' interaction with appliances, the type of alert message, or the type of appliance transmitting the alert message. The alert message and set of events in the file can be transmitted for blocks 64 and 65 via a browser-type application using, for example, standard Internet communication protocols such as HyperText Transport Protocol (HTTP) and Transmission Control Protocol/Internet Protocol (TCP/IP). If the appliance remains on-line with network 40 (block 66), method 50 returns to block 52 to continue recording events for this appliance.

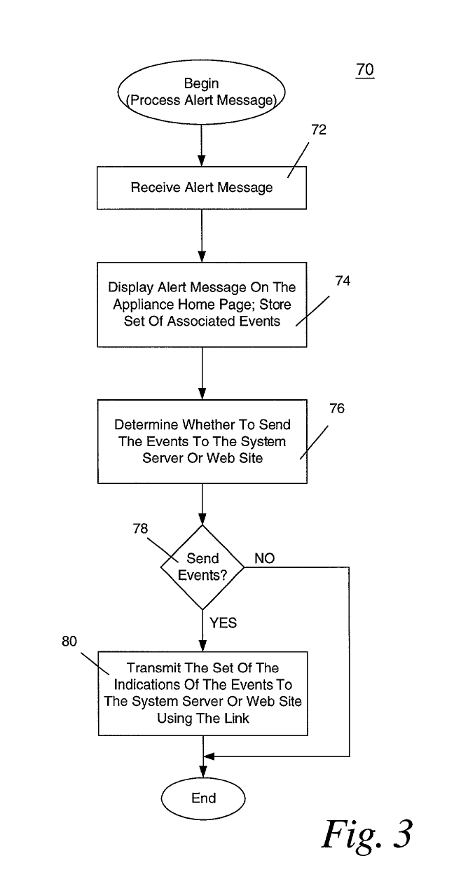

FIG. 3 is a flowchart of a method 70 for processing and displaying alert messages on the client machines 12 and 14. Method 70 may be implemented, for example, in software modules stored within memory 24 for execution by processor 18. In method 70, one or more of the client machines 12 and 14 receives an alert message from one of the networked appliances 28 and 30 (block 72). The client machine displays the alert message on the appliance home page and maintains the associated set of events in the hidden file (block 74).

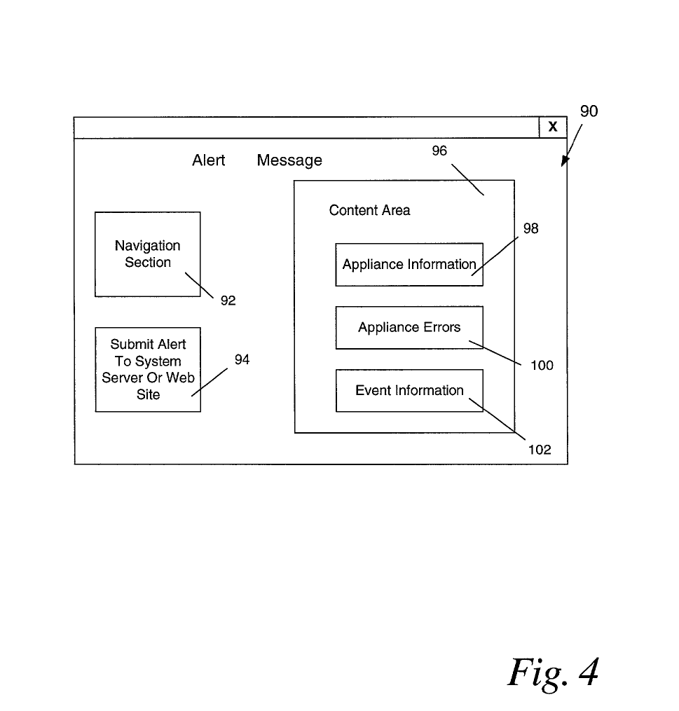

FIG. 4 is a diagram of an exemplary alert message within an appliance home page 90. The alert message may include, for example, a navigation section 92, and a content area 96. Navigation section 92 may include various sections, buttons, or links for selection by the client with a cursor-control device or other inputted command in order to perform network navigation relating to the appliance. Content area 96 may include a section 98 for displaying information concerning the appliance which sent the alert message, an indication of an appliance error in a section 100 that resulted in transmission of the alert message, and information concerning events in a section 102. Content area 96 may include additional or fewer sections than those shown. A client may select section 94, for example, in order to transmit the appliance error and the set of indications of associated events to system server 38. Page 90, and other alert messages, may be formatted as a web page for transmission by a browser-type application, for example, or may be formatted as other types of pages or screens for transmission and display.

Method 70 then determines whether to send the events to system server 38 (block 76). It may send the events based upon client input, such as a client's selection of section 94 or other inputted command, or alternatively it may transmit the events automatically upon detecting transmission of the alert message to the client machine. If the client machine determines that the events are to be sent (block 78), the client machine transmits the set of the indications of the events to system server 38 using the link associated with the page containing the alert message (block 80). The link may represent, for example, a network address or Uniform Resource Locator (URL) identifying a network location of a system server. The information may be transmitted via network 40 using standard Internet communication protocols as identified above.

Accordingly, system server 38 may receive electronically an indication of an error in a networked appliance along with a set of indications of events relating to that error. That information may be transmitted by the client by interaction with the client machine, not necessarily requiring a separate or manual communication by the client.

Table 1 provides an example of XML tags defining the “snapshot” for a printer as a networked appliance, and those tags may be used in this example to generate an XML string capturing the corresponding event information. The tags in this example define the types of events to record for the printer. The information in Table 1 is provided for illustrative purposes only to show an exemplary implementation of the present invention. The type of information to record, such as the tags, and the particular format for recording the information may depend, for example, upon the type of networked appliance, the particular data structure or programming language used, and the events that a client or other person desires to be recorded.

TABLE 1

| Iteration | | | | | | | |
|---|---|---|---|---|---|---|---|
| 1 | 2 | 3 | 4 | 5 | 6 | 7 | Definition |

| XML_Version | | |
|---|---|---|
| Device_Configuration | | |
| | Printer_Information | Base information of the device |

| | |
|---|---|
| Product_Name | Full name of the product |
| Printer_Number | Model number |
| Serial_Number | Serial number |
| Firmware_Datecode | Version Number for printer-internal |
| | software |
| Page_Counts | Page counts for color, B&W and total |
| | page count |

| | |
|---|---|
| Total_Page_{—} | Sum of Black and white plus color |
| Count | |

| | |
|---|---|
| Event_Log | Log of events (or errors) |

| | |
|---|---|
| Event | Definition of a single event (repeated |
| | tag) |

| | |
|---|---|
| Number | Error sequence number |
| Error_Code | Error number |
| Page_Count | Page count corresponding to the error |
| | number |

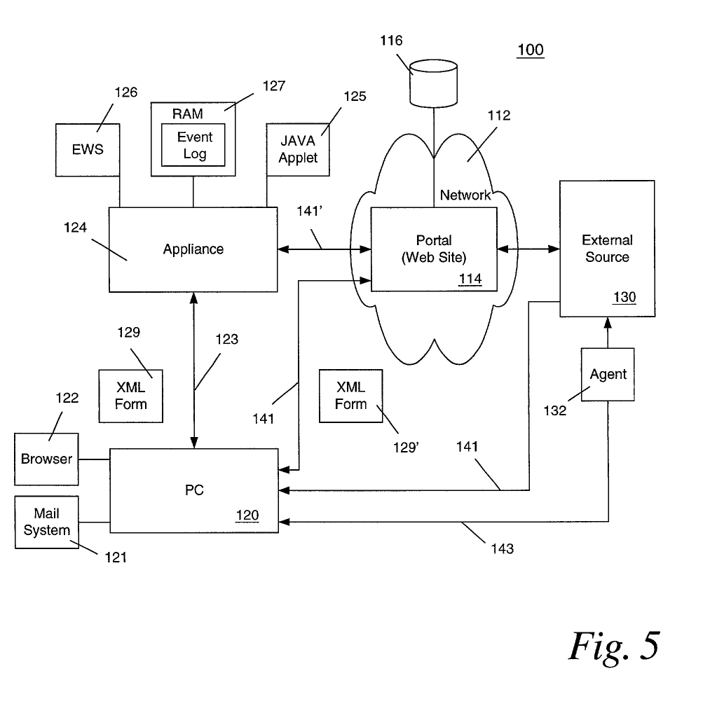

FIG. 5 is a more detailed diagram of a system for gathering data from appliances and for providing information back to a user of the appliances. A system 100 includes a network 112 that includes a portal 114 and a data storage device 116. The network 112 may be the Internet, and the portal 114 may be a Web site, with attendant servers and other processing equipment (not shown). Alternatively, the network 112 may be a local area network (LAN) or wide area network (WAN) and the portal 114 may be a node in the LAN or WAN. The network 112 can also be any other communications network capable of supporting digital data.

Coupled to the network 112 is one or more appliances, such as the appliance 124. The appliance 124 includes a memory such as the RAM 127. The RAM 127 may store an event log, which will be described in detail later. The appliance 124 may also include a processor and programming, such as an embedded web server 126 that is capable of generating an instruction such as a Java applet 125 and an XML form 129. Use of the Java applet 125 and the XML form 129 will also be described in detail later. Embedded web servers are known in the art, and include EMSO's Chai and Apache units.

The appliance 124 may be implemented as a networked device that is coupled directly to the network 112, and may include additional components depending upon the type of appliance. For example, if appliance 124 is implemented with a printer, the appliance 124 will also include the necessary mechanical and other components to receive information and print the information onto paper or other material.

Other examples of appliances that may be used in the system 100 include a facsimile machine, a personal computer, home appliances such as televisions and refrigerators, business machines such as servers, communications devices such as switching circuits, and other devices. Furthermore, the appliances need not be hard-wired to the network 112, and other mobile applicances including motor vehicles, for example, may use the system 100.

Also shown in FIG. 5 is a client machine, or personal computer (PC) 120, that may be operated under control of a human client. The PC 120 may be coupled to the appliance 124 and to the network 112, and may include an input device (e.g., keyboard, mouse), a display, a processor, a memory, and the necessary programming to generate a browser 122 or other device capable of communication with the network 112. The client machine may also be implemented as a personal data assistant (PDA) or similar device, or a wireless telephone. The client machine may communicate with the network 112 and the appliance 124 using wired or wireless communications paths. In an embodiment, the client machine (e.g., the PC 120) and the appliance 124 may be combined into a single device.

In FIG. 5, the PC 120 communicates with the appliance 124 using communications path 123, which may be a wired or wireless communications path. Using the communication path 123, the appliance 124 may send the XML form 129 to the PC 120. The PC 120 communicates with the network 112 using communication paths 141, which may be wired or wireless communications paths. Optionally, the appliance 124 may communicate directly with the network 112 using communication path 141′, which may be a wired or wireless communications path.

Using the communication path 141, the PC 120 may send XML form 129′ to the portal 114. The XML form 129′ is similar to the XML form 129, but has passed through the PC 120. In an alternative configuration, the appliance 124 may send the XML form 129 directly to the portal 114 using the communication path 141′.

Finally, the system 100 includes one or more external services, such as the external service 130 in communication with the network 112. The external service 130 may be another node in the network 112 (e.g., another Web site), a node in another network, or a “brick and mortar” establishment, for example. The external service 130 may include one or more agents, such as the agent 132. In an embodiment, the agent 132 is a human operator that interacts with a client at the client machine (i.e., at the PC 120). The external service 130 may communicate with the PC 120 using the communication path 141 and may also communicate using the communication path 143. In an embodiment, the communication path 143 may be a “physical” path, such as U.S. Postal Service, a courier system (e.g., Federal Express®), or other physical pathway.

Similar to the system 10 described above, the system 100 may be used to extract or receive information from the appliance 124 and to provide information and possibly products and services back to the client. Use of the system 100 for these functions will be described in detail later.

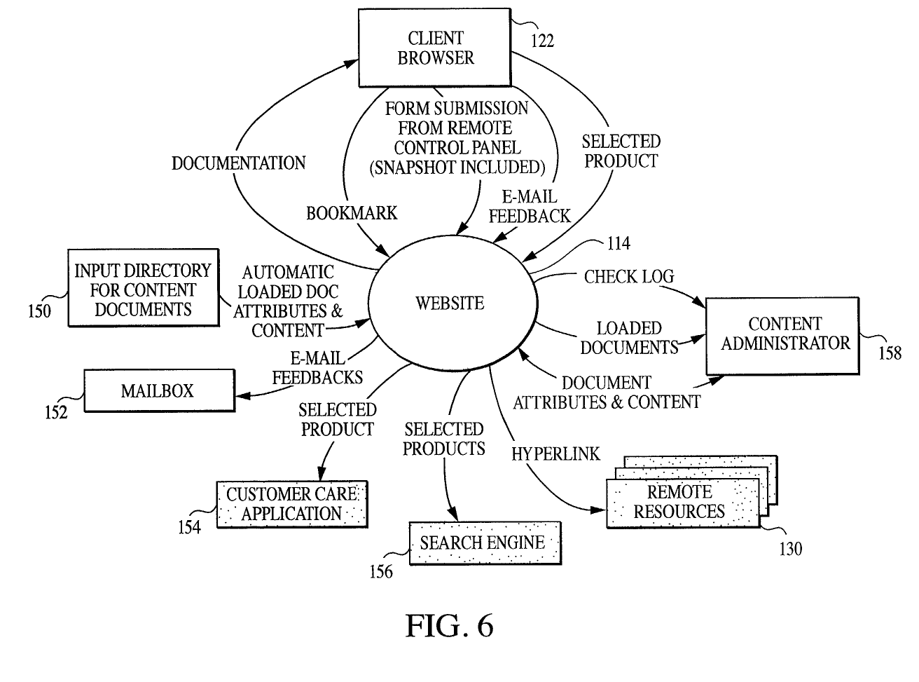

FIG. 6 is a high-level overview of data sources in the system 100 that may provide data for storage in the database 116. The database 116 is shown receiving information from, and providing information to the browser 122 (see FIG. 5). The database 116 may receive e-mail feedback form a client, information about a selected product or appliance, a form submission (e.g., the XML form 129′-see FIG. 5), and a bookmark, and may provide documentation about an appliance to the client at the PC 120, for example. The database 116 operates under control of a content administrator 158, which may be a program resident on a server or other processor at the portal 114. Remote sources 130 may be coupled to the database 116 through a hyperlink path, for example.

A search engine 156 may be accessible at the portal 114 to allow searches of the database 116, in particular to search for data related to specific appliances or products. A customer care application 154 provides detailed information about a selected product or appliance. The customer care application 154 will be described in more detail later. A mailbox 152 may receive e-mail feedback from clients who use the system 100. Finally, an input directory 150 provides for automatic loading of documentation related to specific appliances that are coupled to the network 100.

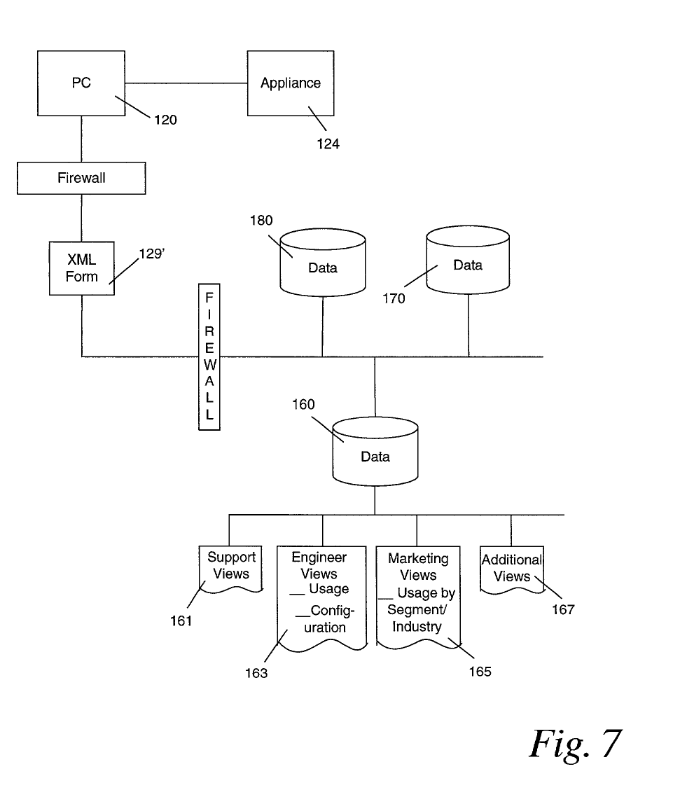

FIG. 7 is a more detailed diagram of the database 116. The database 116 includes one or more data segments that may be devoted to supporting a particular type of appliance. In an embodiment supporting printers, a data segment 160 stores printer information for remote printers. The printer information may be arranged in further memory segments or files. A support views file 161 stores data related to parts, consumables, and other similar components for one or more remote printers. An engineer views file 163 stores usage and configuration information for one or more remote printers. A marketing views file 165 stores usage information by industry/market segments for one or more remote printers. An additional views file 167 stores additional information for one or more remote printers. Data segments 170 and 180 may support other types of appliances.

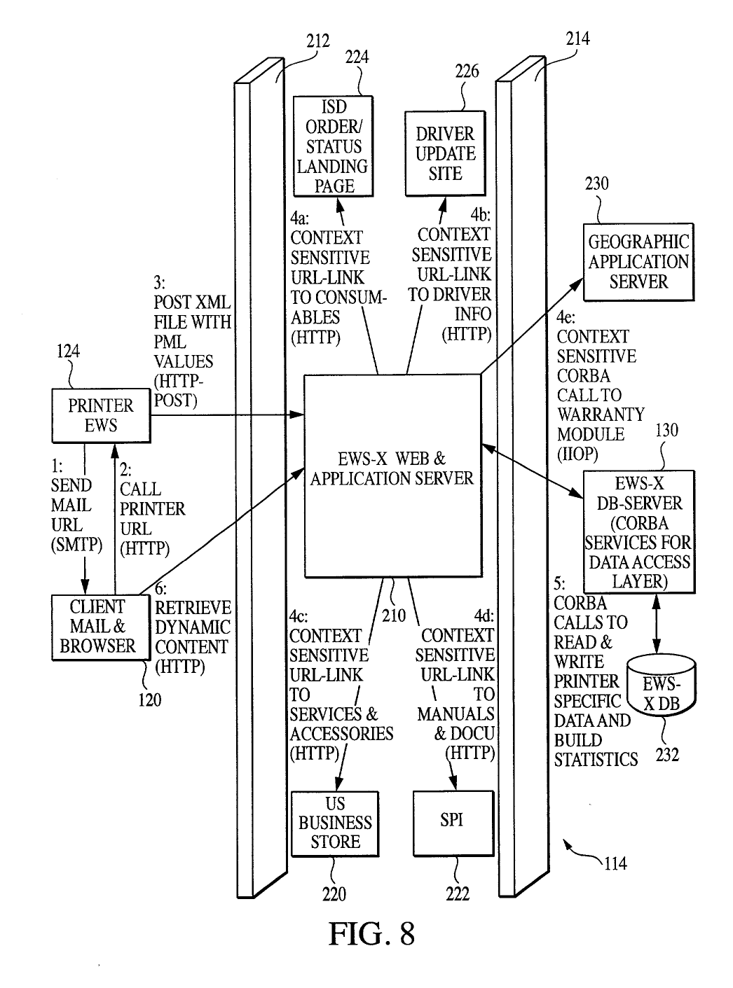

An architecture of the portal 114 (implemented in a preferred embodiment as a Web site) is shown in FIG. 8. In FIG. 8, the portal 114 is shown supporting a printer as an embodiment of the appliance 124. The portal 114 is a dynamic Web site that provides an interpreted response to a browser session initiated from the PC 120. The architecture includes at the Web site an application server 210 that may be based on a secure architecture framework. The server 210 receives and manages all servelets, objects, and other data required to operate the portal 114. The server 210 is coupled to external sources through firewalls. A firewall 212 controls data flow between the server 210 and the PC 120. A firewall 214 controls data flow between the server 210 and external sources 130. In an embodiment shown in FIG. 8, the external source 130 is an embedded Web server-external database (EWS-X DB) server, and is shown coupled to an EWS external database 232. In another embodiment, the functions of the external server 130 may be executed by the server 210, and the data may be stored in a database directly coupled to the server 210.

The server 210 is shown coupled to a store 220, which may be a “brick and mortar” establishment that provides services related to the portal 114. That is, the store 220 may be affiliated with an entity operating the portal 114. Also coupled to the server 210 is a support part inventory (SPI) database 222, that provides an online database of parts to support the appliance 124, an imaging support division (ISD) landing page 224, which is a home page for services in support of the appliance 124, and a site 226 that provides updated software, such as printer drivers, to the PC 120. The SPI 222 may also provide an e-commerce feature, or e-store, that allows a client to purchase a part for the appliance 124. Finally, a geographic application server 230 is shown coupled to the server 210 through the firewall 214. The geographic application server 230 includes routines, programming ad data that are unique to a specific geographic region, and that account for variations in customs, laws and regulations, and technical requirements related to the communications and internet access, for example. A separate geographic application server 230 may be provided for: 1) North America; 2) Europe, Middle East and Africa; 3) Asia and Pacific; and 4) South America, for example.

An operation of the portal 114 is shown in FIG. 8, with step 1, the appliance 124 (a printer with an embedded Web server) sending a mail message with a URL to the PC 120. In step 2, the PC 120 calls the URL. In step 3, an XML file 129 is posted to the server 210. In a preferred embodiment, the PC 120 posts the XML file 129′ to the server 210. In another embodiment (shown in FIG. 8), the appliance 124 posts the XML file 129 directly with the server 210. The server 210 determines one or more actions to suggest, based on information contained in the XML file (i.e., the event log). In step 4a, the server 210 creates a context-sensitive URL link to a Web page that allows the client to order various consumables (e.g., a toner cartridge, inkjet container, etc.). In step 4b, the server 210 creates a context-sensitive URL to a software Web page that allows the client to download operating software such as an updated printer driver. In step 4c, the server 210 creates a link to services and accessories. In an embodiment, the client may indicate acceptance of a specific service or may order an accessory. An agent 132 (see FIG. 5) may then initiate a call back to the client to schedule the service. Alternatively, the agent 132 may communicate with the client using e-mail for example. In step 4d, the server 210 may create a link to a Web page that provides electronic versions of documents and manuals related to the appliance. The documents and appliances then may be downloaded to the PC 120. In step 4e, the server 210 creates a CORBA call to a warranty module (which may be accessed through the geographic application server 230). The warranty module may provide specific warranty information related to the appliance 124, and may offer the client an opportunity to upgrade or extend an existing warranty. The CORBA call may be made regardless of the nature of the information included in the XML file posted with the server 210 in step 3. In step 5, the server 210 makes a CORBA call to the external server 130 to gather and compile statistical information related to the appliance 124. Such data may be stored in the database 232. In step 6, the PC 120 retrieves dynamic content from the Web site server 210.

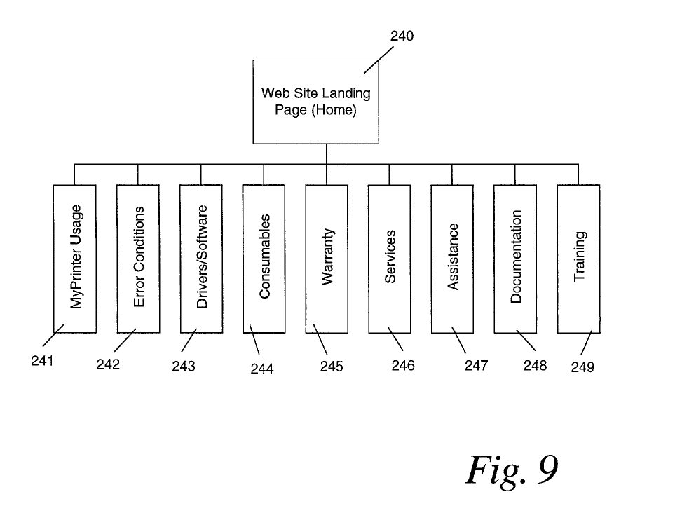

FIG. 9 is a logical diagram of functions available at the portal 114. The functions are shown as they may appear to a client accessing a Web site home page of the portal 114. A home page 240 is presented to the client when the browser session is initiated. The home page 240 includes links to pages related to one or more appliances. In the example shown in FIG. 9, the home page 240 links to a my printer usage page 241 that display printer usage information for the client's printer. Other pages include an error condition page 242, a driver software page 243, a consumables page 244, a warranty page 245, a services page 246, an assistance page 247, a documentation page 248, and a training page 249.

The above listed Web pages allow the client to access a variety of services and to purchase products related to one or more appliances. For example, the assistance page 247 may include a self-help section. The self-help section may include links to error messages related to the client's appliance, and to other information related to the client's appliance. The self-help section may provide links to a customer care page, electronic manuals that relate to the appliance, and an “ask the expert” service that provides quick answers to appliance support questions. A tools, tips and tricks section, on the assistance page 247, for example, may provide links to virtual appliance simulators that simulate a client's control panel, generic trouble shooting advice, performance enhancements, and a bulletin board for sharing experiences among clients. The customer care page may provide access to sub-pages for generic information related to the appliance type, specific information related to the appliance model/configuration, and technical support for the appliance. The technical support sub-page may provide access to other pages for set-up and maintenance of the appliance, downloads, problem-solving tips, uses for the appliance, appliance features and specification, supplies and accessories for the appliance, frequently asked questions, appliance technical manuals (e.g., the documentation page 248) and warranty information (e.g., the warranty page 245).

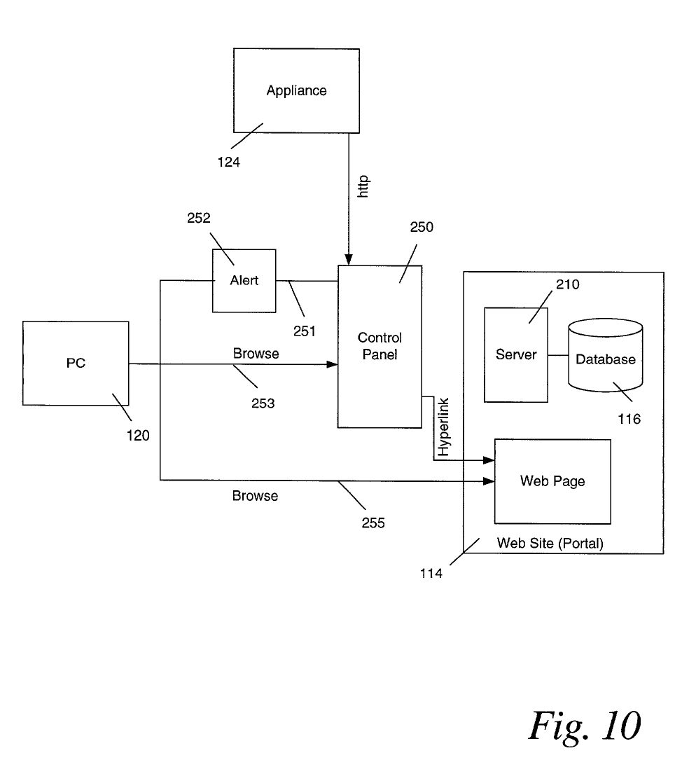

FIG. 10 illustrates three possible usage models applicable to the portal 114 shown in FIG. 5. The portal 114 (dynamic Web site) includes the server 210 and the database 116. The client uses the appliance 124 (illustrated in this example as a printer) and the PC 120. The portal 114 provides dynamic content specific to the status of the appliance (printer) 124. The appliance (printer) 124 includes an embedded Web server (not shown). The server 210 and the database 116 support content (e.g., manuals, printer information) and maintain appliance and client data and history. The PC 120 may display a remote control panel 250, which in this example, is an emulated printer control panel that can be called over the browser 122 (not shown in FIG. 10), and is generated by the embedded Web server of the appliance (printer) 124. In an embodiment, the appliance 124 may interact directly, using the http path, with the control panel 250.

In a first usage case, an alert 252 is sent by the appliance (printer) 124 directly to the PC 120. The alert 252 includes a hyperlink 251 to the remote control panel 250. This is the default access to the portal 114, and carries a snapshot (i.e., the XML form) 129 formatted in XML or other markup language that is received by the server 210. The server 210 evaluates the snapshot data, and if the snapshot is well-formed (i.e., includes proper XML syntax for transmission over the communication path to the portal 114), the server 210 creates a session, posting a home page to the browser 122. The server 210 creates a virtual device, defined by a selection of relevant appliance elements, and based on data contained in the snapshot.

When a well-formed snapshot is received at the portal 114, the server 210 analyzes the data contained in the snapshot and evaluates any error messages according to a set of business rules. The server 210 may then return a page (e.g., the remote control panel 250) that contains specific information based on the results of the evaluation process. For example, the information may indicate that frequent paper jams have occurred in a printer, and that the suggested fix is to replace a worn drive wheel. The suggestion may include links to purchase the drive wheel from an associated Web site, or to schedule a repair visit by one of the agents 132 (see FIG. 5). Other evaluated problems may result in suggestions for self-help, including a step-by-step illustrated process to correct a problem, replace a part, or to change appliance settings.

If a snapshot is not received, or if the snapshot is not well-formed, the client may be presented with a Web page displaying options available to the client for initiating a session. A snapshot gathering option recommends that the client access the remote control panel 250 and activate a snapshot gathering resource (e.g., activate a link to the appliance 124) so that the client can launch a full, customized session. A navigation option allows the client to navigate all pages, sub-pages, sections and sub-sections of the portal 114. The navigation option also presents a dialog box that allows the client to enter an appliance number (identification) that will be passed to the server 210 to present general support information about the appliance. The dialog box may include a pulldown list of appliances and corresponding appliance numbers for appliances supported by the portal 114. If the client enters an appliance selection, a session is initiated, but without specific information about the appliance status. A customer care option allows the client to select an appliance from a pulldown list of supported appliances. A session is then initiated with a profile containing only the selected appliance.

In a second usage case, the browser 122 browses 253 directly to the remote control panel 250, for example by using a bookmark in the browser 122. The bookmark may be registered by the client during a prior session, allowing the client to access a URL, which contains the appliance identification, of the portal 114. The remote control panel 250 includes a hyperlink to the portal 114, and when the link is activated, snapshot data is transmitted from the appliance (printer) 124 to the portal 114 using XML or other markup language, to the server 210. In a third usage case, the client browses 255 directly to the portal 114, using, for example, a bookmark in the browser 122. In the third usage case, no snapshot data is submitted. In this third usage case, the client may enter an appliance number, as discussed above, an the server 210 may initiate a session. However, the session will not be based on any appliance status. The third usage case may also be used when the client first registers an appliance with the dynamic Web site (i.e., the portal 114). The third usage case may also be used as a search feature to access information about a supported appliance. For example, the client could enter a command such as http://productfinder.support.hp.com/servlet/Findlt to access a URL for a specific appliance.

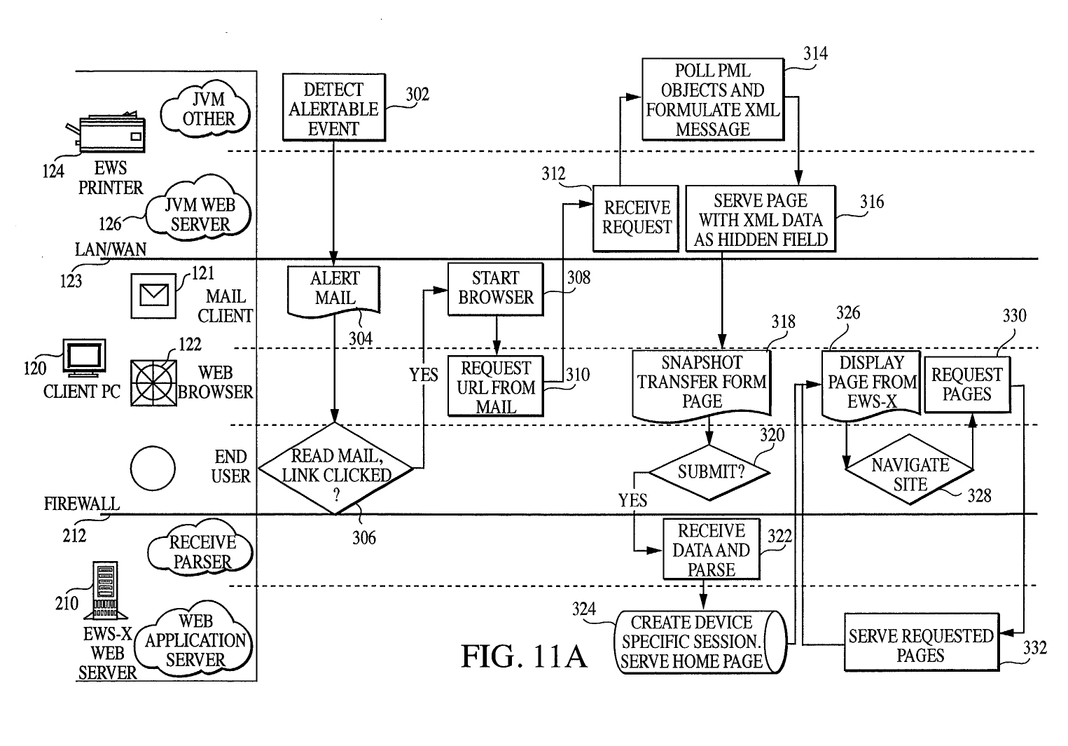

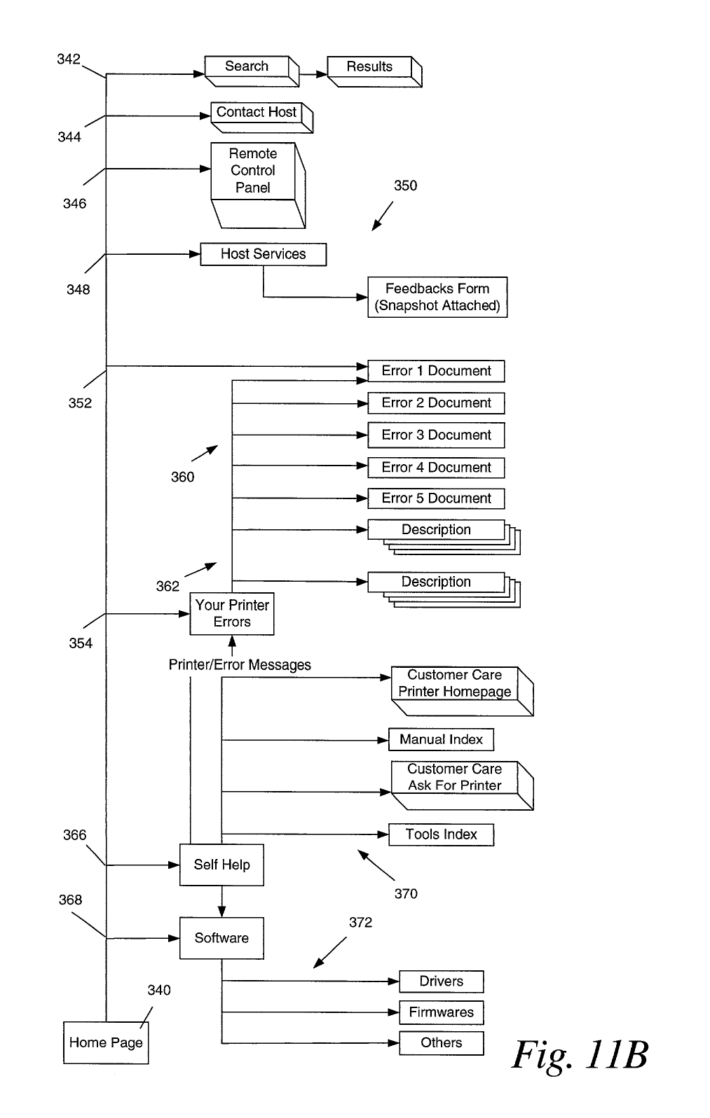

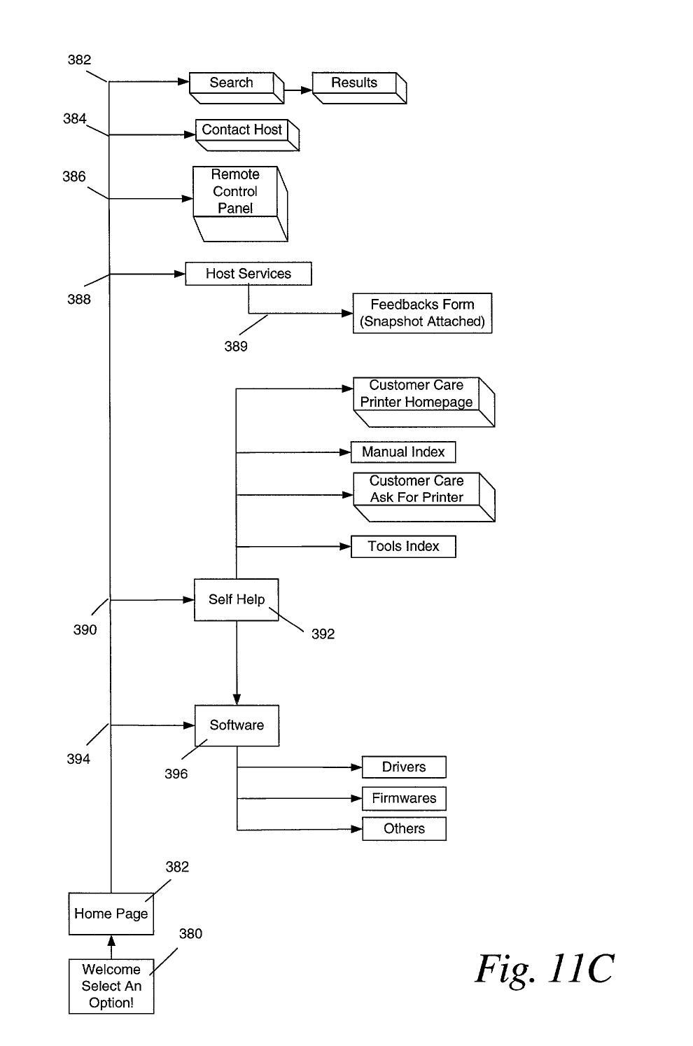

FIG. 11A is a detailed workflow model for an embodiment of an alert process that uses the system 100 of FIG. 5. In FIG. 11A, the appliance (printer) 124 is coupled to the PC 120 by the LAN/WAN 123. The PC 120 is coupled through the firewall 212 to the server 210 at the portal 114. The alert process begins when the processor in the appliance (printer) 124 detects an alertable event (e.g., a paper jam) block 302, and sends the event to the PC 120. The PC 120 receives the event information and the mail system 121 formats an alert message, block 304. The alert message may be displayed until acknowledged by the client. In block 306, the client reads the alert message and selects (clicks) the embedded link to the portal 114. The client could also choose not to select the link, and may cancel the alert message instead.

Once the client selects the link, the mail system in the PC 120 starts the browser 122, block 308. In block 310, the browser 122 requests a URL of the portal 114 from the mail system 121. The request is received by the embedded web server 126, block 312. In block 314, in response to the request, the processor in the appliance (printer) 124 polls the objects and formulates the XML form 129. In block 316, the embedded web server 126 serves a page with the XML data as a hidden field. The XML form 129 may be formed from event information contained in the appliances event log. The event log in formation may be extracted according to the following XML string:

<Event Log>

<Max_Number_of_Entries></Max_Number_of_Entries>
<Number_of_Entries_in_Use></Number_of_Entries_in_Use>
<Event>

<Number></Number>
<Error_Code></Error_Code>
<Page_Count></Page_Count>

</Event>
<Event>

<Number></Number>
<Error_Code></Error_Code>
<Page_Count></Page_Count>

</Event>
<Event>

<Number></Number>
<Error_Code></Error_Code>
<Page_Count></Page_Count>

</Event>

</Event_Log>

In block 318, the browser 122 receives the XML form and generates a snapshot transfer form page. The client may view the snapshot transfer form page and decide to cancel the transfer, or to send the XML form to the portal 114. If the client elects to send the XML form (block 320), a parser in the Web server 210 receives the XML data and parses the XML data, block 322. The Web application server creates a device specific session and serves the Web site home page, block 324.

In block 326, the browser 122 displays the page from the portal 114 on a display device of the PC 120. The displayed page may include several navigation features that allow the client to navigate to other pages or parts of the Web site, and to request display of any associated pages. In block 328, the client navigates to another page linked to the home page. In block 330, the browser 122 requests the selected page. In block 332, the application server 210 serves the requested page, and awaits a request for another page.

FIG. 11B is a block diagram showing various navigation options provided by the portal 114 (see FIG. 5) for a normal use of the portal 114. Navigation begins by accessing the homepage, navigation option 340. In navigation option 342, the search feature is selected, a popped up page is provided by the server 210, and a search is conducted and results are provided to the PC 120. In navigation option 344, the contact service feature is selected (for example, a call to the service, a find feature, and an e-mail to the service). In navigation option 346, the remote control panel 250 (see FIG. 10) is provided.

In navigation option 348, a select services feature is provided with links to support and repair services, contracts and services, warranty information, and e-mail feedbacks. In navigation option 350, a feedback form is provided.

In navigation option 352, the alerts at a glance feature is selected, and a page is returned showing current appliance errors. Note that the PC 120 must have provided a well-formed XML snapshot with event data for analysis by the server 210. In navigation option 360, individual appliance errors can be selected, and documentation related to the error is provided to the PC 120. In navigation option 362, either a numbered or an unnumbered error message is selected and information related to the error message is provided.

In navigation option 354, an appliance errors selection is received, and a page displaying the errors is provided to the PC 120. The page may display a specific error, a current error, or a history of errors.

FIG. 11C is a diagram of navigation options of the portal 114 of FIG. 5 when only an appliance number (identification) is provided from the PC 120. An opening screen is presented, navigation option 380, and the client is prompted to select an option. In navigation option 382, the homepage is provided to the PC 120, and the client is prompted to select an appliance number. Selection may involve use of the pulldown list of available appliances. From the homepage, the client can chose navigation option 382 to search for a specific appliance or for other information, navigation option 384 to contact the host of the portal 114, navigation option 386 to access the control panel for the selected appliance, and navigation option 388 to access services from the portal 114. If navigation option 388 is selected, then further navigation options 389 allow the client to connect to various services associated with the portal 114. The services include support and repair, contracts and services, warranty and e-mail feedbacks. The client may also choose navigation option 390 and the self help page may be provided to the PC 120. The self help page allows the client to access information about an appliance, provides self help links, and provides tools, tips and tricks. Using navigation option 392, the client can browse these various features.

Finally, the client may choose navigation option 394 and a software page will be provided to the PC 120. A further navigation option 396 then provides pages for downloading software.

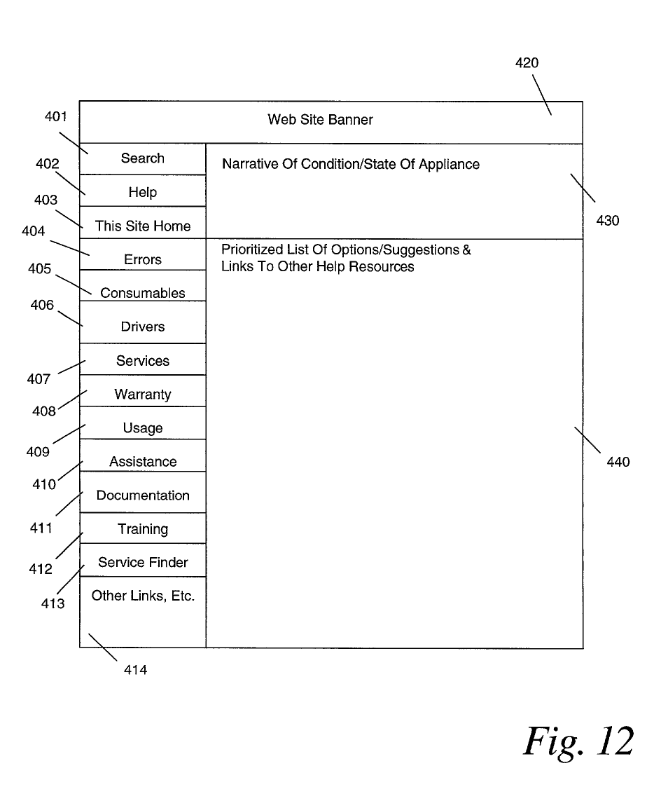

FIG. 12 is a diagram of a generic home page 400 used with the portal 114. The home page 400 includes links 401-414 to other pages, services, web sites, and other features. The home page 400 also includes a banner section 420 that displays specific appliance-identifying information, an application status block 430 that displays a current or historical status of the appliance, and a display section 440 that provides a prioritized list of options/suggestions, and includes links to other help resources.

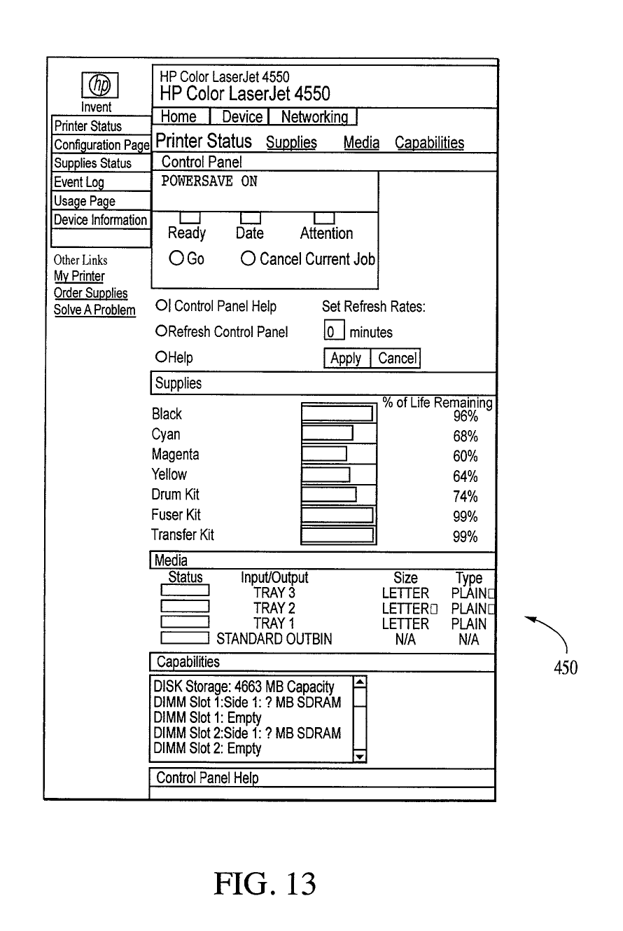

FIGS. 13-16 are examples of specific home pages provided at the portal 114. FIG. 13 shows a printer status page 450 that may be displayed for a specific printer, in this example, a HP color laserjet 4550 printer.

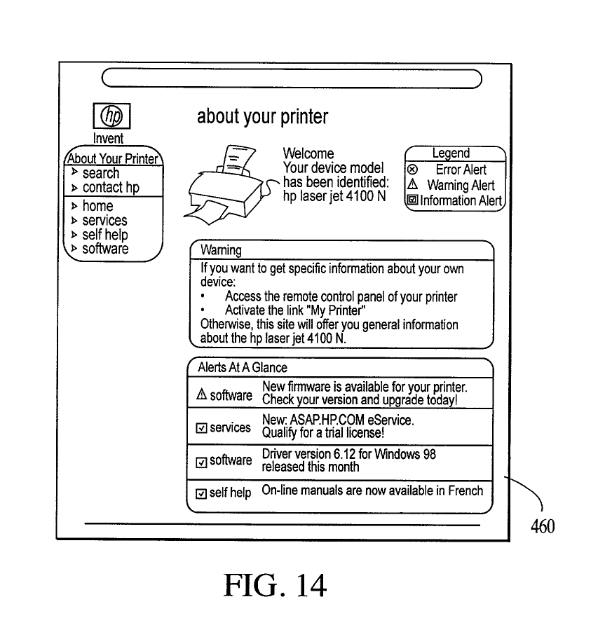

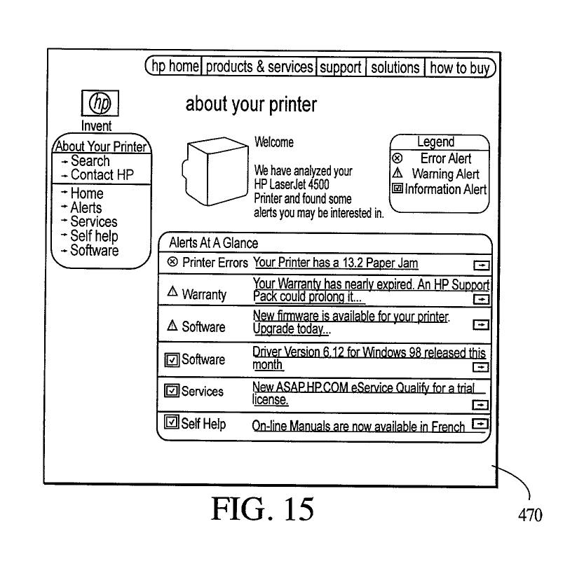

FIG. 14 shows an “about your printer” page 460. FIG. 15 shows an “about your printer” page 470 that may be used for a HP laserjet 4500 printer. The page 470 is shown as it appears at the PC 120, and after a well-formed snapshot has been received at the portal 114.

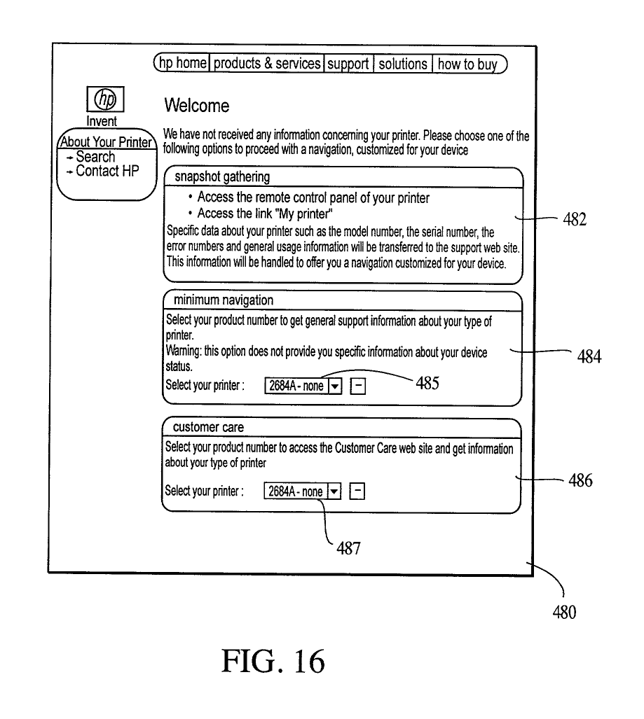

FIG. 16 shows an alert page 480 that may be displayed when the client has linked directly to the portal 114 (see usage case 3, FIG. 10), or has sent the XML form 129, but the XML form 129 is not well-formed. The alert page 480 includes a snapshot gathering section 482 that prompts the client to access the remote control panel 250 (see FIG. 10) and to initiate a snapshot gathering process by activating a link to the appliance 124. A navigation section 484 allows the client to enter an appliance identification number, using, for example, a pulldown list 485, to receive specific information about the selected appliance. The navigation section 484 minimizes navigation through the portal 114, and allows the client to receive generic product information, such as product upgrades, software and programming changes, and other information related to the selected appliance. In particular, the client may be presented with a Web page that displays information about the class of appliance selected, and may navigate to a further Web page that addresses the specific appliance selected. If the client does not select an appliance, the client may be directed to a customer care Web page. The customer care Web page may also be accessed using a customer care section 486. A pulldown list 487 allows the client to select an appliance and to access the customer care Web page to receive specific information related to the selected appliance.

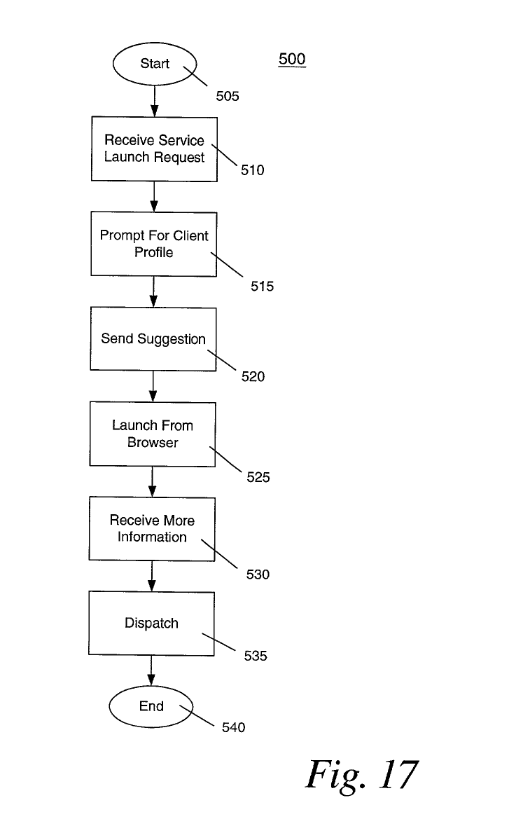

FIGS. 17-26 are flowcharts illustrating processes completed by the portal 114. In FIG. 17 a flowchart shows an overall process 500 in the system 100 shown in FIG. 5, for providing information or access to services based on receipt of a well-formed snapshot 29. The process 500 begins with block 505. In block 510, the server 210 receives a service launch request from the PC 120. The server 210 processes the service launch request and, if required, prompts the client to supply client profile information, block 515. In block 520, the server 210 posts a page to the PC 120 that includes suggestions based on the identity of the appliance 124 and any received event information. In block 525, the server 210 receives a launch request from the session browser. In block 530, the server may request more information, based on the selected service option. In block 535, the server 210 dispatches the selected service. The process ends in block 540.

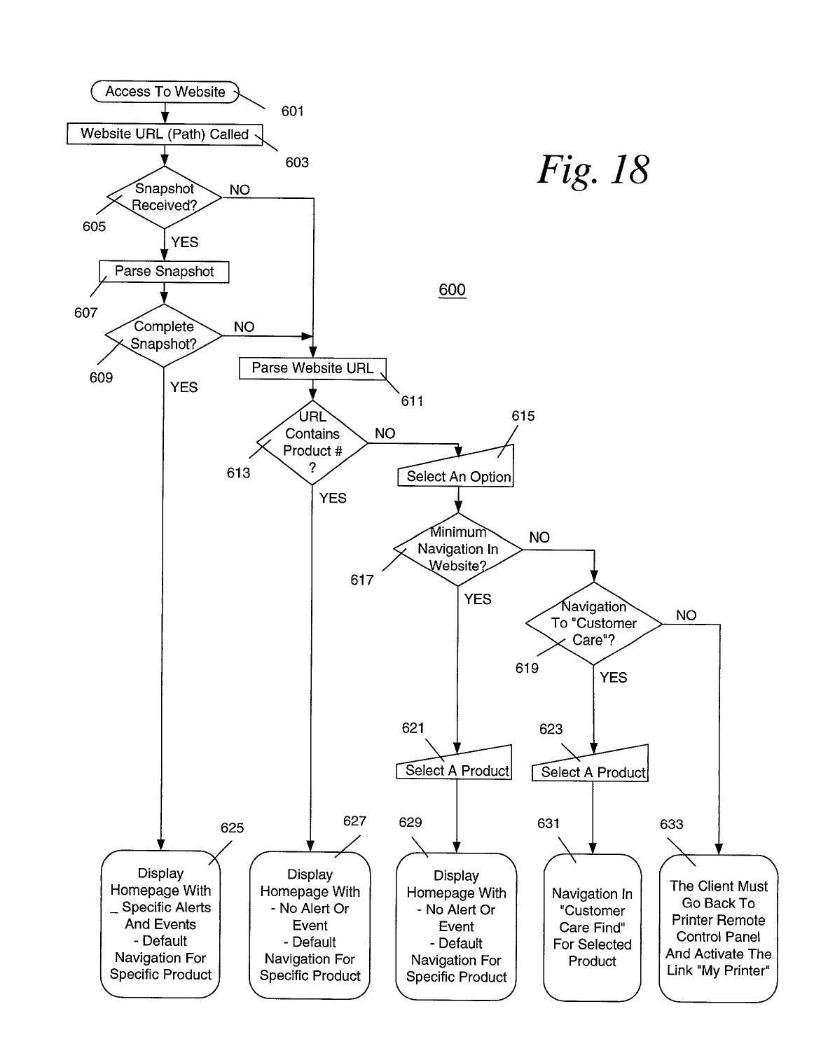

FIG. 18 is a flowchart showing a product identification process 600. In block 601, the Web site is accessed by the client. In block 603, the PC 120 calls the Web site URL. In block 605, the server 210 determines if a snapshot is received. If a snapshot is received, the snapshot is parsed, block 607, to extract the last five events recorded in the event log for the appliance 124. In block 609, the server 210 determines if the parsed snapshot is complete. If the parsed snapshot is complete, the server 210 provides the homepage with specific alerts and events, and provides normal navigation for a specific appliance (block 625). In block 605, if a snapshot is not received, or in block 609, if the received snapshot is not well-formed, the server 210 parses the web site URL, block 611. In block 613, the server 210 determines if the parsed URL contains the appliance identification number (e.g., a serial number and appliance model number). If the appliance identification number is provided, the server 210 provides the homepage but without alerts or events, and provides normal navigation for the selected appliance, block 627. If the URL does not contain the appliance identification number, the server 210 prompts the client to select an option, block 615. In block 617, the server 210 determines if the client has selected minimum navigation. If minimum navigation is selected, the server 210 prompts the client to select an appliance, block 621. The server then displays the home page without alerts or events, and provides normal navigation for the selected appliance. In block 617, if the server 210 determines that minimum navigation was not selected, the server 210 determines if the client has elected to navigate to the customer care site, block 619. If navigation to the customer care site is chosen, the server 210 prompts the client to select an appliance, block 623. When an appliance is chosen, the server 210 allows the client to navigate in the customer care site for the selected appliance. In block 619, if the server 210 determines that the client has not chosen to navigate to the customer care site, the remote control panel is returned to the PC 120, block 633.

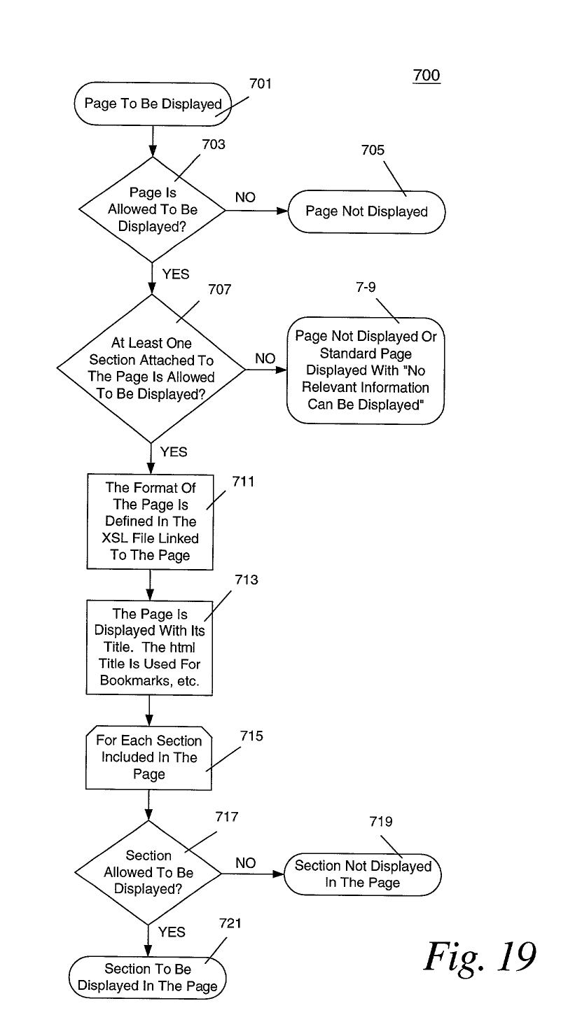

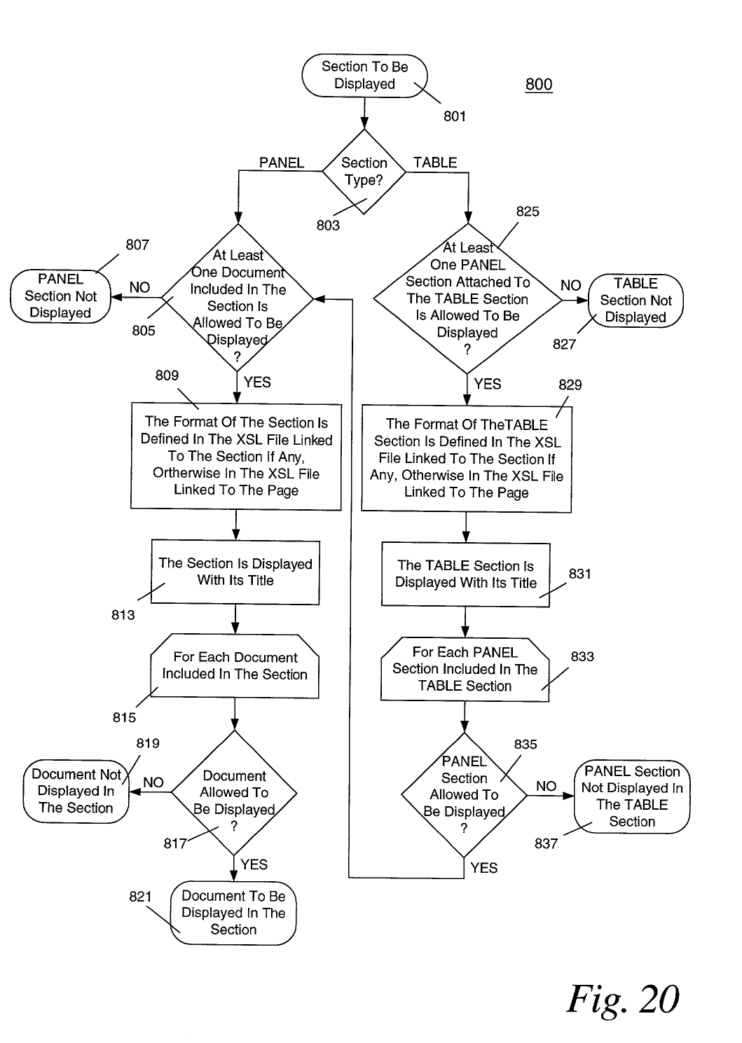

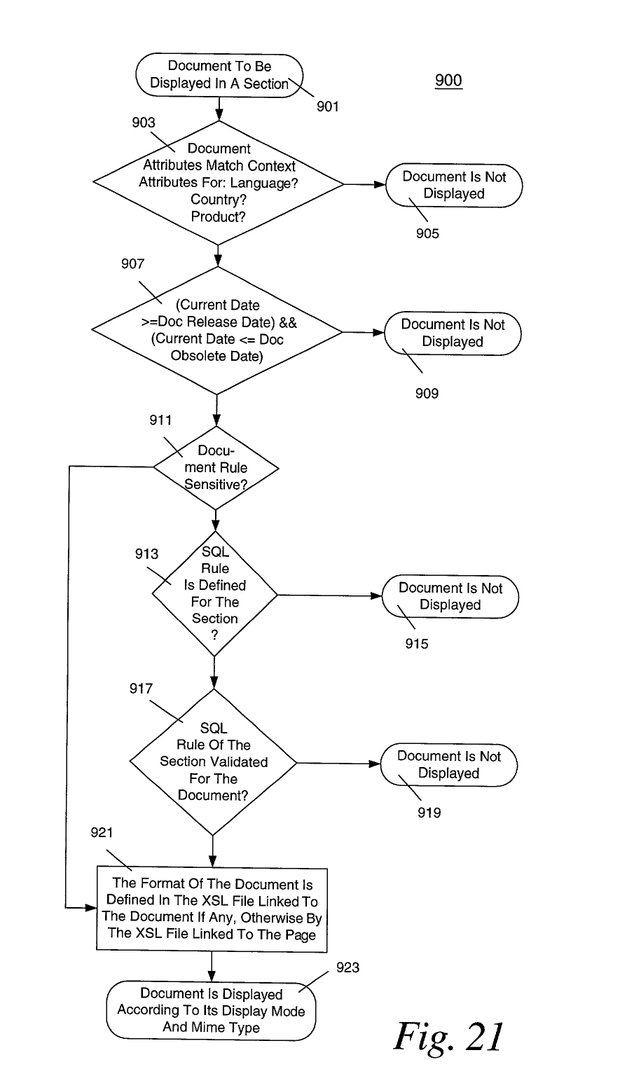

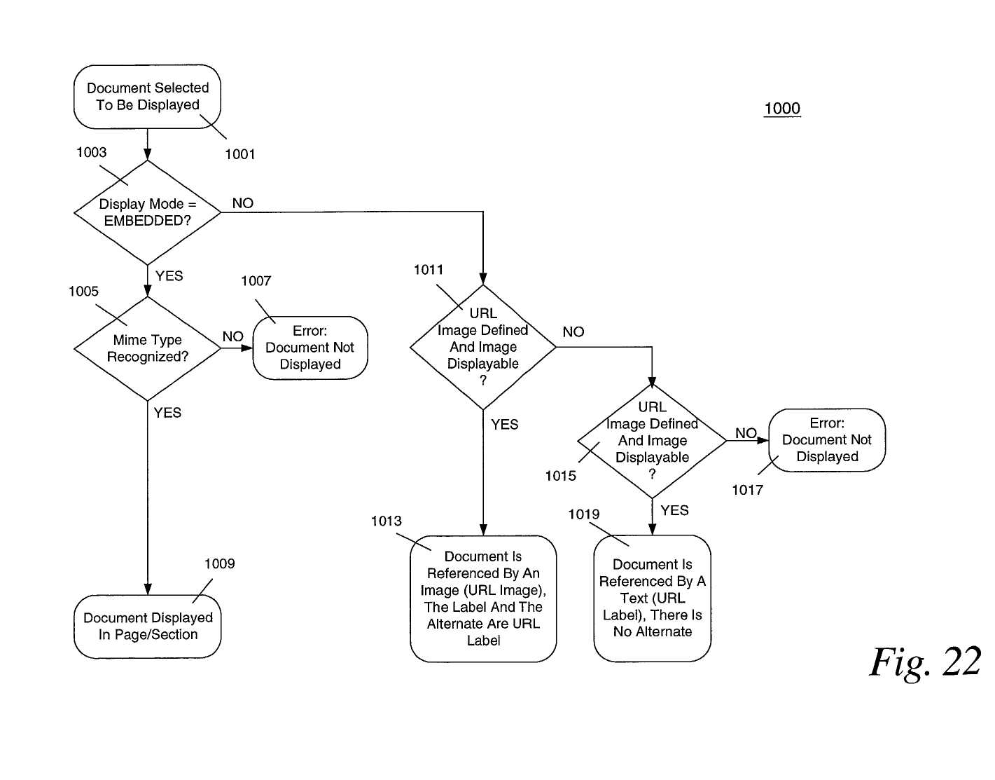

FIG. 19 is a flowchart showing a page selection process 700. FIG. 20 is a flowchart showing a section selection process 800. FIG. 21 is a flowchart showing a document selection process 900. FIG. 22 is a flowchart showing a document display process 1000.

In the illustrated embodiments, the functionality of launching a service request directly from a network-enabled appliance can be provided for by using a suitably programmed Web site server and a database. However, the functions of the portal 114, and its sub-components, including the server 210, also may be carried out by a single, special purpose integrated circuit (e.g., an ASIC) having a main or central processor section for overall, system-level control, and separate circuits dedicated to performing various different computations, functions and other processes under control of the central processor section. Those skilled in the art will appreciate that the portal 114 may also be implemented using a plurality of separate, dedicated or programmable integrated or other electrical circuits or devices (e.g., hardwired electronic or logic circuits such as discrete element circuits, or programmable logic devices such as PLDs, PLAs, or PALs). The portal 114 may also be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the flowcharts shown in FIGS. 2, 3, 11A-C, and 17-22 can be used as the portal 114, or its sub-components.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. In a network, a method for launching a service or purchasing a product directly from a network-enabled appliance, comprising:
in response to a request to launch a service or purchase a product from a device coupled to the network, creating a session specific to the network-enabled appliance;
receiving a request from the device; and
responding to the request.

2. The method of claim 1, wherein the creating step includes posting a page in the device, the page including request options for selection from the device.

3. The method of claim 2, wherein the request options include self-help, download software, download manuals, purchase a product, and obtain service.

4. The method of claim 1, wherein the request includes one or more of a service request and a product purchase request.

5. The method of claim 1, wherein the responding step comprises launching a service case, comprising:
contacting a service agent, wherein the service agent is provided with information related to the request and the network-enabled appliance;
establishing a communication link with the device, wherein the communication link provides the response to the request.

6. The method of claim 5, wherein the communication link is a link to a further page, the further page providing information related to products and services and providing a purchase option.

7. The method of claim 6, wherein the purchase option includes purchasing downloadable software from a linked site.

8. The method of claim 1, wherein the network is the Internet.

9. An apparatus, located at a node in a network, that launches services and purchases products based on direct requests from a network-enabled appliance, comprising:
a server that receives information related to the network-enabled appliance and provides options for requesting services and products, the server, comprising:
a client browser that provides communication between the server and a device remote from the node, wherein the device receives event information from the network-enabled appliances and provides the event information to the server,
a search engine that provides search functions related to information stored at the node, and
one or more pages that provide access to the services and the products; and
a database that stores information related to the network-enabled appliance.

10. The apparatus of claim 9, wherein the client browser is launched in response to an event message provided to the server by the device, and wherein the network-enabled appliance provides the event message to the device.

11. The apparatus of claim 9, wherein when the server receives a request for a service or a product, the server provides a prompt to acquire profile information related to a client that owns the network-enabled appliance.

12. The apparatus of claim 11, wherein the profile information includes information for contacting the client.

13. The apparatus of claim 12, wherein an agent contacts the client to arrange the service.

14. The apparatus of claim 9, wherein the service or a product purchase is launched directly from the client browser.

15. The apparatus of claim 9, wherein the server creates a browser session specific to the network-enabled appliance.

16. A method for launching a service or purchase request directly from a browser, comprising:
receiving information related to a network-enabled appliance, the information indicative of an error in the appliance;
processing the information to determine suggested responses to the error;
posting a first page at a device coupled to the appliance, the first page providing the suggested responses; and
receiving the request for the service or purchase, wherein the request is selected from the provided suggested responses.

17. The method of claim 16, wherein the suggested responses include linking to one or more second pages, wherein the one or more second pages are specific to the appliance, the one or more second pages, comprising:
a self-help page, wherein the self-help page includes tips, tools tricks and links to self-help features;
a software download page, wherein the server provides software related to operation of the appliance;
a warranty page, wherein warranty information related to the appliance is provided, and wherein warranty coverage may be purchased;
a services page that lists services suggested for the appliance based on the error; and
a documentation page that provides links to electronic manuals and documents related to the appliance.

18. The method of claim 16, wherein the suggested responses include linking to a service agent, wherein the service agent arranges a service call.

19. A method for launching services in response to an event at a network-enabled appliance, comprising:
receiving event information from a device coupled to the appliance, wherein the appliance provides the event information to the device;
processing the event information to generate suggested responses, wherein the suggested responses are specific to the appliance;
posting a first page with the device, the first page including the suggested responses;
receiving a selection of one or more of the suggested responses; and
launching a service in response to the received selection.

20. The method of claim 19, wherein the service includes one or more of a product purchase, a repair service, a self-help service, a software download service, and a document delivery service.

21. The method of claim 19, wherein the service is provided by linking the device to a second page that includes the service.

22. The method of claim 19, wherein the event information includes an appliance identification.

23. The method of claim 19, wherein the event information includes appliance error information.

24. The method of claim 19, wherein documentation and software related to the appliance is provided automatically upon receipt of the event information.

25. A method for launching services in response to information about a network-enabled appliance, comprising:
receiving information related to the appliance;
first processing the information to determine if the information includes event information;
if the information includes event information, determining if the event information is well-formed;
if the event information is well-formed, generating suggested responses, wherein the suggested responses are specific to the appliance;
posting a first page, the first page including the suggested responses;
receiving a selection of one or more of the suggested responses; and
launching a service in response to the received selection.

26. The method of claim 25, wherein if the information does not include event information, providing a prompt to supply the event information.

27. The method of claim 26, wherein if the event information is not supplied in response to the prompt, parsing an address to determine an identification of the appliance.

28. The method of claim 27, wherein if the appliance identification is not provided, prompting selection of an appliance.
